(19) United States
(12) Patent Application Publication
(10) Pub. No.: US 2024/0323298 A1
(43) Pub. Date: Sep. 26, 2024

(54) INFORMATION PROCESSING DEVICE, CONTROL METHOD OF INFORMATION PROCESSING DEVICE, AND RECORDING MEDIUM

(71) Applicant: CANON KABUSHIKI KAISHA, Tokyo (JP)

(72) Inventor: TAKUMI MAEDA, Kanagawa (JP)

(21) Appl. No.: 18/605,752

(22) Filed: Mar. 14, 2024

(30) Foreign Application Priority Data
Mar. 20, 2023 (JP) 2023-044203

(51) Int. Cl. H04N 1/32; H04N 1/00

(52) U.S. Cl. CPC H04N 1/32106; H04N 1/00413; H04N 1/00464

(57) ABSTRACT

An information processing device comprising: a memory storing instructions; and a processor executing the instructions causing the information processing device to: receive a selection of one utilization environment selected from the plurality of utilization environments; perform setting for a plurality of setting items by using the plurality of first setting values in association with the selected one utilization environment; save a plurality of second setting values corresponding to the plurality of setting items that are set before the setting by using the plurality of first setting values is performed; and provide a report including the saved plurality of second setting values and a plurality of third setting values set for the information processing device when an instruction to provide the report is received, which correspond to at least some of the plurality of setting items, on the basis of the instruction to provide the report from a user.

### BACKGROUND OF THE INVENTION

### Field of the Invention

The present invention relates to setting of a security-related function of an information processing device.

### Description of the Related Art

In general, information processing devices connected to networks have a setting function of setting security-related functions on the basis of user's operations. In recent years, information processing devices have been installed in various environments such as home offices or public spaces shared by an unspecified number of people, and the required security setting has become complicated. Japanese Patent Laid-Open No. 2007-185814 discloses a technique of collectively performing setting of security-related functions of an image processing device in accordance with a security level by a user designating security levels provided in a stepwise manner.

However, according to Japanese Patent Laid-Open No. 2007-185814, the user cannot check setting values before collective setting after collective setting has been performed. Although a change in setting values of the security-related functions is a trade-off relationship with convenience, and deterioration in convenience may occur due to limitation of functions after collective setting, it is difficult for the user to recognize which changes of setting values have led to the degradation of convenience.

### SUMMARY OF THE INVENTION

The present invention enhances convenience related to collective setting of setting items related to security.

Provided is an information processing device according to the present invention comprising: a memory storing instructions; and a processor executing the instructions causing the information processing device to: receive a selection of one utilization environment from the plurality of utilization environments; perform setting for a plurality of setting items by using the plurality of first setting values in association with the selected one utilization environment; save a plurality of second setting values corresponding to the plurality of setting items that are set before the setting by using the plurality of first setting values is performed; and provide a report including the saved plurality of second setting values and a plurality of third setting values set for the information processing device when an instruction to provide the report is received, which correspond to at least some of the plurality of setting items, on the basis of the instruction to provide the report from a user.

Further features of the present invention will become apparent from the following description of embodiments with reference to the attached drawings.

### BRIEF DESCRIPTION OF THE DRAWINGS

FIG. 1 is a diagram illustrating an example of installation environments of information processing devices.

FIG. 2 is a flowchart illustrating categorization of installation environments.

FIG. 3 is a diagram illustrating a hardware configuration of an image processing device.

FIG. 4 is a diagram illustrating a software configuration of the image processing device.

FIG. 5 is a diagram illustrating an example of a security collective setting screen according to a first embodiment.

FIG. 6 is a diagram illustrating an example of a setting change report according to the first embodiment.

FIG. 7 is a flowchart illustrating processing of providing a setting change report according to the first embodiment.

FIG. 8 is a flowchart illustrating processing of providing the setting change report according to the first embodiment.

FIG. 9 is a diagram illustrating an example of a security collective setting screen according to a second embodiment.

FIG. 10 is a diagram illustrating an example of a setting change report according to the second embodiment.

FIG. 11 is a flowchart illustrating processing of providing the setting change report according to the second embodiment.

FIG. 12 is a flowchart illustrating processing of providing a setting change report according to a third embodiment.

FIG. 13 is a diagram illustrating an example of a security collective setting screen according to a fourth embodiment.

FIG. 14 is a diagram illustrating an example of a setting change screen according to the fourth embodiment.

FIG. 15 is a flowchart illustrating processing related to the setting change screen according to the fourth embodiment.

### DESCRIPTION OF THE EMBODIMENTS

### First Embodiment

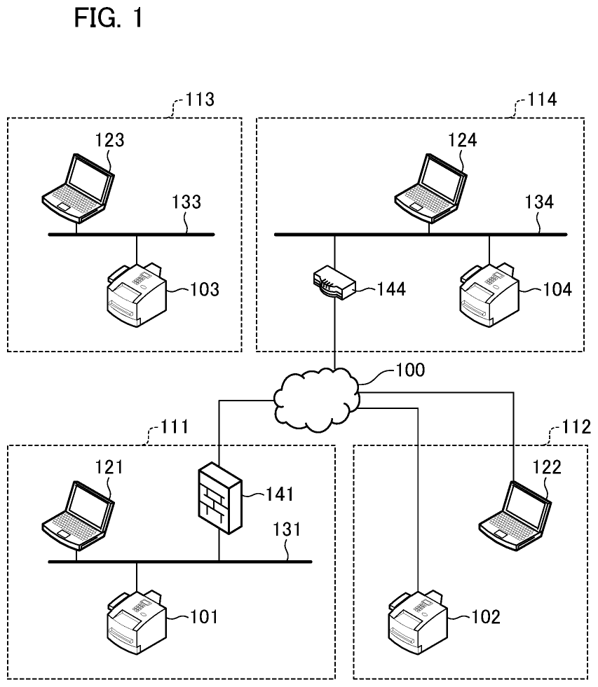

FIG. 1 is a diagram illustrating an example of installation environments of information processing devices according to the present embodiment. Image processing devices 101 to 104 that are examples of the information processing device according to the present embodiment are installed in mutually different installation environments. Specifically, the image processing device 101 is installed in a company intranet environment 111, the image processing device 102 is installed in an Internet directly connected environment 112, the image processing device 103 is installed in an Internet prohibited environment 113, and the image processing device 104 is installed in a home office environment 114.

The image processing devices 101 to 104 are image processing devices including a scanner and a printer, such as a multifunction peripheral (MFP). Note that the image processing devices 101 to 104 may have other functions such as a facsimile function and a box function and may not include a printer or a scanner. The image processing devices 101 to 104 may be 3D printers or 3D scanners. The image processing devices 101 to 104 are network devices capable of performing communication. PCs 121 to 124 are examples of information processing devices. The PCs 121 to 124 are network devices capable of performing communication. Although security setting in accordance with installation environments of image processing devices will be described in the present embodiment, the devices for which security setting is performed may be any information processing devices capable of performing communication via a network, such as PCs, smartphones, or image forming devices.

The image processing devices 101 to 104 have a function of setting security setting values for the image processing devices themselves in accordance with the installation environments. Here, installation environments of the image processing devices assumed in the present embodiment will be described. A plurality of types of installation environments are defined by a vendor on the basis of installation locations of image processing devices, utilization environments of the image processing devices, connection states of the image processing devices with respect to networks, whether or not confidential information is included in information assumed to be used by the image processing devices, and the like. As the installation environments, it is possible to assume, for example, a company intranet environment, an Internet prohibited environment an Internet directly connected environment, a public space environment, a home office environment, a highly confidential information management environment, and the like. An administrator of an image processing device selects one type to be set for the image processing device from among a plurality of types as options of an installation environment of the image processing device defined by the vendor.

Security settings to be set for the image processing device are different for each installation environment. For example, a file sharing function is a function of sharing a file on a network in an environment, and it is desirable that the file sharing function be invalidated in an environment where undefined users share a network in the environment in order to prevent information leakage. In other words, invalidation of the file sharing function is recommended except for private network environments in which specific users share networks in the environments. The private network environments in the present embodiment are a company intranet environment, an Internet prohibited environment, and a home office environment. Therefore, excluding these, invalidation of the file sharing function is recommended in an Internet directly connected environment, a public space environment, and a highly confidential information management environment. As an example of settings related to the function sharing function, there is server message block (SMB) server setting. Note that above definition of the installation environments does not limit the present invention and some installation environments illustrated as examples in the present embodiment and other installation environments may be defined. For example, installation environments may be categorized for each business type, such as finance or a government office, on the assumption of installation in companies.

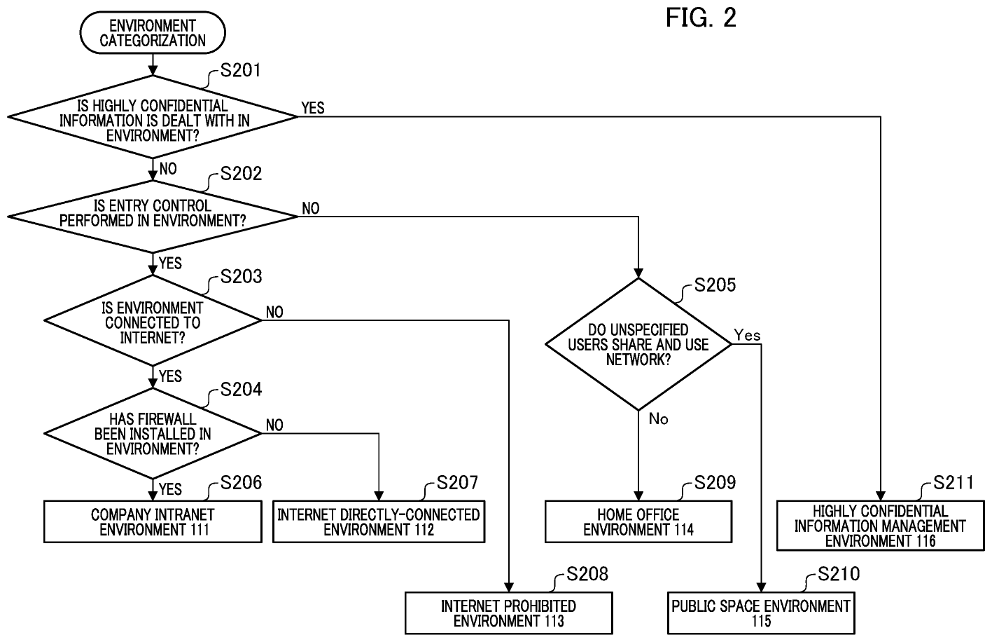

FIG. 2 is a flowchart illustrating categorization of installation environments. S201 is categorization of whether or not information with high confidentiality is dealt with in the environment. In a case where information with high confidentiality is dealt with in the environment, the installation environment is categorized as a highly confidential information management environment 116 in S211. The highly confidential information management environment 116 is an environment, in which highly confidential information is dealt with, for which a highest priority is to be placed on security measures. On the other hand, in a case where information with high confidentiality is not dealt with in the environment, categorization in S202 is performed.

S202 is categorization of whether or not entry to the environment is controlled. This is an example of categorization based on whether or not unspecified users can physically access the information processing device, that is, whether or not users who enter the location where the information processing device is installed are limited. Therefore, this categorization condition is not limited to whether or not the users who can physically access the image processing device are specified through entry control, and conditions other than the entry control may be categorization conditions. Also, the entry control in the present embodiment is not limited to a building entry/exit system using a card. For example, an environment where only persons who belong to an organization work in business hours, where persons who can practically enter the room are limited, and where a door is locked outside of business hours are also included as an environment with entry control.

In a case where entry control is not performed, that is, undefined users can physically access the information processing device, the installation environment is subdivided depending on the categorization condition illustrated in S205. S205 is categorization of whether or not undefined users share and use a network in the environment. In a case where undefined users share a network in the environment, the installation environment is categorized as a public space environment 115 in S210. The public space environment 115 is an environment in which undefined users share and use a network in the environment. On the other hand, in a case where undefined users do not share the network in the environment, the installation environment is categorized as a home office environment 114 in S209. The home office environment 114 is an environment where undefined users do not share the network in the environment. Note that in the present embodiment, the environment where undefined users do not share the network in the environment like the home office environment 114, that is, environments where users can be specified is defined as a private network environment.

The installation environment categorized as an environment with entry control in S202 is further subdivided depending on the categorization condition illustrated in S203. S203 is categorization of whether or not the image processing device in the environment is connected to an external network such as the Internet. In a case where the image processing device is not connected to an external network such as the Internet, the installation environment is categorized as an Internet prohibited environment 113 in S208. The Internet prohibited environment 113 is an installation environment where entry control is performed, connection to an external network such as the Internet is not established, and a closed network is assumed. Note that the Internet prohibited environment 113 where entry control is performed and a closed network is assumed is a private network environment.

In a case where the image processing device in the environment is connected to an external network such as the Internet, the installation environment is further subdivided depending on the categorization condition illustrated in S204. S204 is categorization of whether or not a firewall has been installed. In a case where a firewall has been installed, the installation environment is categorized as a company intranet environment 111 in S206. On the other hand, in a case where a firewall has not been installed, the installation environment is categorized as an Internet directly connected environment 112 in S207. Note that the company intranet environment 111 where users who use the network in the environment can be limited by a firewall is a private network environment.

Description will return to FIG. 1. The company intranet environment 111 is an environment to which the image processing device 101 and the PC 121 are connected via a local area network (LAN) 131 inside a company. A firewall 141 is installed at a boundary between the LAN 131 and the Internet 100. In other words, communication between each information processing device inside the company intranet environment 111 and the Internet 100 is monitored and protected by the firewall 141. Therefore, a threat such as an access of an attacker to each information processing device from the Internet 100 is significantly reduced in the company intranet environment 111.

The Internet directly connected environment 112 is an environment where the image processing device 102 and the PC 122 are connected to the Internet 100 and perform communication. No firewall is installed in the Internet directly connected environment 112. Therefore, the information processing devices such as the image processing device 102 and the PC 122 need measures against a threat such as an access of an attacker from the Internet 100 by using a personal firewall function or the like in each information processing device.

The Internet prohibited environment 113 is an environment where the information processing devices such as the image processing device 103 and the PC 123 are connected via a LAN 133 but are not connected to the Internet 100. The Internet prohibited environment 113 is a closed network environment isolated from different networks such as the Internet 100, and network communication can be performed only between the information processing devices installed on the LAN 133. Therefore, the information processing devices such as the image processing device 103 and the PC 123 in the Internet prohibited environment 113 cannot be accessed by unspecified users on the Internet 100.

The home office environment 114 is an environment to which the image processing device 104 and the PC 124 are connected via a home LAN 134. The LAN 134 is a private network configured of a home router 144. Although the image processing device 104 and the PC 124 are connected to the Internet 100 via the LAN 134 and the home router 144, fixed security measures achieved by the firewall 141 as in the company intranet environment 111 are not present. Therefore, the information processing devices such as the image processing device 104 and the PC 124 installed in the home office environment 114 need to have measures against a threat such as an access of an attacker from the Internet 100 similarly to the Internet directly connected environment 112. In other words, the information processing devices such as the image processing device 104 and the PC 124 installed in the home office environment 114 need to have measures against a threat such as an access of an attacker from the Internet 100 by using a personal firewall function in each information processing device. Note that the network may be configured by any of or a combination of a communication network such as a LAN or a WAN, a cellular network (LTE or 5G, for example), a wireless network, a telephone line, a dedicated digital line, and the like. In other words, it is only necessary for the network to which the image processing device is connected to be configured such that data transmission and reception can be performed, and any communication scheme may be used.

Here, security measures performed for each installation environment (utilization environment) will be described by using Table 1. Table 1 is a table illustrating security measures recommended for each installation environment. In Table 1, there are indications of “ON” for items, the setting of which is recommended. Also, enhancement of security levels is recommended for the setting items with the indications “ON”, and in other words, this means that there are functional limitations. The setting items for which the setting values are blanks (oblique lines) in Table 1 represent that there are no recommended setting values. The image processing devices 101 to 104 have a function in which setting values (a plurality of first setting values) for security settings recommended for a selected installation environment are applied all together once a user selects the installation environment.

TABLE 1

| | | | | | | Highly |
|---|---|---|---|---|---|---|
| | | | Internet | | | confidential |
| | Company | Internet | directly | | | information |
| | intranet | prohibited | connected | Home office | Public space | management |
| | environment | environment | environment | environment | environment | environment |
| Encryption of | ON | | ON | ON | ON | ON |
| communication path | | | | | | |
| Invalidation of | ON | | ON | ON | ON | ON |
| legacy protocol | | | | | | |
| Validation of | | | ON | ON | ON | ON |
| personal firewall | | | | | | |
| Enhancement of | ON | | ON | ON | ON | ON |
| authentication | | | | | | |
| safety | | | | | | |
| Measure against | | | | ON | ON | ON |
| physical attack | | | | | | |
| Invalidation of | | | ON | | ON | ON |
| file sharing | | | | | | |
| function | | | | | | |
| Invalidation of | ON | ON | ON | ON | ON | ON |
| external storage | | | | | | |
| device | | | | | | |

The image processing devices 101 to 104 have a variety of setting items such as setting items related to security functions and other setting items and execute various kinds of control in accordance with setting values corresponding to the setting items. The present embodiment will be described by exemplifying seven setting items for security setting, namely encryption of a communication path, invalidation of a legacy protocol, validation of a personal firewall, enhancement of authentication safety, a measure against a physical attack, invalidation of a file sharing function, and invalidation of an external storage device.

The encryption of the communication path is a security measure for preventing information leakage by encrypting communication content on the network. As an example of a function realizing encryption of the communication path, there is transport layer security (TLS). Since there is a probability that the communication content is eavesdropped by a third person in the environment connected to the Internet, it is desirable that the communication path be encrypted. In other words, encryption of the communication path is recommended except for the Internet prohibited environment 113.

The invalidation of the legacy protocol is a security measure for preventing impersonation and information leakage by invalidating a function of using a legacy communication protocol which is not safe. As an example of the legacy protocol, there is Windows Internet Name Service (WINS). It is desirable that the invalidation of the legacy protocol be also set in the environment connected to an external network such as the Internet, similarly to the encryption of the communication path. In other words, the invalidation of the legacy protocol is recommended except for the Internet prohibited environment 113.

The personal firewall means a firewall that is installed in and used by the information processing device. Similarly to an ordinary firewall, the firewall monitors communication between the information processing device and an external network such as the Internet. As examples of the firewall, there are an IP filter and a port number filter. The IP filter is a security measure that reads transmission destination information and transmission source information of communication packets and permits only communication packets set in advance. It is thus possible to prevent improper access and to prevent information leakage. The port number filter is a security measure that closes ports that are not to be used and prevent invasion from ports. It is thus possible to prevent Denial of Service (DoS) which is a cyber attack imparting a large load and causing vulnerability. Since there is a likelihood of information leakage and DoS in an environment connected to an external network and including no firewall installed therein, it is desirable that a personal firewall be validated. In other words, validation of a personal firewall is recommended except for the Internet prohibited environment 113 which is not connected to an external network and the company intranet environment 111 for which a firewall has been set.

The enhancement of authentication safety means enhancing a measure against impersonation by inhibiting password caching or designating the minimum number of letters for a password, for example. It is desirable to enhance authentication safety except for the Internet prohibited environment 113 which is connected within an isolated network since there is a likelihood of impersonation.

The physical attack measure is a security measure of preventing information from physically leaking. In the image processing devices 101 to 104, temporary data such as a print job is generated in a hard disk. The image processing devices 101 to 104 includes a complete deletion function of automatically completely deleting generated temporary data at the same time with an end of a job. Examples of the physical attack measure of the image processing devices 101 to 104 include the complete deletion function. If the function has been set, temporary data is not read even in a case where the hard disc is physically pulled out. It is desirable that the physical attack measure be carried out in the home office environment 114 and the public space environment 115 that are environments, for which entry control is not performed, in which it is not possible to limit physical access to the information processing devices. Also, it is desirable that the physical attack measure is carried out even in the highly confidential information management environment 116 in which highest priority is placed on reduction of a risk of information leakage.

The file sharing function is a function of sharing a file on a network in an environment. In an environment in which undefined users share a network in an environment, it is desirable that the file sharing function be invalidated in order to prevent information leakage. In other words, invalidation of the file sharing function is recommended except for private network environments in which specified users share networks in the environments. As described above, the private network environments in the present embodiment are the company intranet environment 111, the Internet prohibited environment 113, and the home office environment 114. Therefore, invalidation of the file sharing function is recommended except for these, that is, in the Internet directly connected environment 112, the public space environment 115, and the highly confidential information management environment 116. Note that as an example of setting related to the file sharing function, there is a server message block (SMB) server setting.

The invalidation of the external storage device means performing setting such that a universal serial base (USB) storage device, for example, cannot be used as an external storage device in the image processing devices 101 to 104. It is thus possible to prevent information from being written in an external storage device and to prevent information leakage. Also, it is possible to prevent computer virus infection via the USB storage device and accompanying information leakage. A threat of information leakage using an external storage device such as USB is common to any installation environment. Therefore, it is desirable that external storage devices be invalidated in all installation environments.

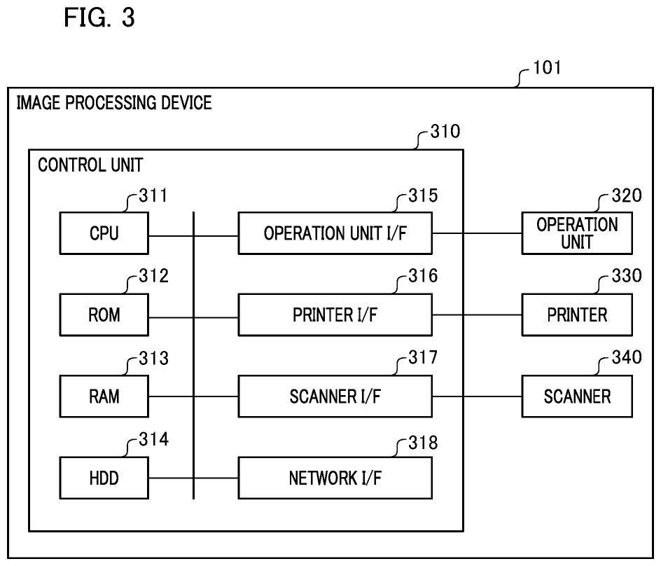

A hardware configuration of the image processing device 101, which is an example of the information processing devices, will be described by using FIG. 3. FIG. 3 is a diagram illustrating a hardware configuration of the image processing device. Note that although only the image processing device 101 will be described in FIG. 3, it is assumed that the image processing devices 102 to 104 and the image processing devices installed in the public space environment 115 and the highly confidential information management environment 116, which are not illustrated, have also similar configurations to that of the image processing device 101.

The image processing device 101 includes a control unit 310, an operation unit 320, a printer 330, and a scanner 340. The control unit 310 controls operations of the entire image processing device 101. The control unit 310 includes a CPU 311, a ROM 312, a RAM 313, an HDD 314, an operation unit I/F 315, a printer I/F 316, a scanner I/F 317, and a network I/F 318.

The central processing unit (CPU) 311 reads a control program stored in the ROM 312 or the HDD 314 and executes various kinds of control processing of the image processing device 101. The read only memory (ROM) 312 stores programs to be executed by the CPU 311. Control performed by the CPU 311 includes execution of the programs to realize the flowcharts, which will be described later. The random access memory (RAM) 313 is used as a temporary storage memory such as a main memory and a work area of the CPU 311. The hard disk drive (HDD) 314 is a storage device that stores image data, various programs, and various kinds of setting information. Note that the image processing device 101 may include another storage device such as a solid state drive (SSD) as a storage device.

The operation I/F (interface) 315 establishes connection between the operation unit 320 and the control unit 310. The operation unit 320 includes a display unit including a touch panel function and various hard keys, for example. It is possible to configure a GUI as if the user were able to directly operate the screen displayed on the touch panel, by associating input coordinates with display coordinates on the touch panel. The operation unit 320 functions as a display unit that displays information for the user and a receiving unit that receives instructions from the user.

The printer I/F 316 establishes connection between the printer 330 and the control unit 310. The printer 330 prints an original document read by a reader and image data stored in the HDD 314 on a recording medium (on a paper, for example). Also, the printer 330 prints image data on the basis of a print job. The image data to be printed by the printer 330 is transferred from the control unit 310 via the printer I/F. The scanner I/F 317 establishes connection between the scanner 340 and the control unit 310. The scanner 340 reads an original document placed on an original document table and generated image data. The generated image data is input to the control unit 310 via the scanner I/F 317. Note that although the example in which the image processing device 101 has a printing function and a scanning function has been described in the present embodiment, it is only necessary for the image processing device 101 to include at least either the printing function or the scanning function.

The network I/F 318 is an interface for communication that establishes connection between the image processing device 101 and a network such as the LAN 131. The image processing device 101 can execute communication with an external device via the network I/F. Note that although it is assumed that the network I/F 318 is a communication interface that performs wired communication in the present embodiment, the network I/F 318 is not limited thereto. For example, the network I/F 318 may be a wireless communication interface. Note that although the network I/F 318 of the image processing device 101 is connected to the LAN 131, a network to be connected differs depending on an installation environment. For example, the image processing device 102 is connected directly to the Internet 100. Also, the image processing device 103 is connected to the LAN 133, and the image processing device 104 is connected to 134.

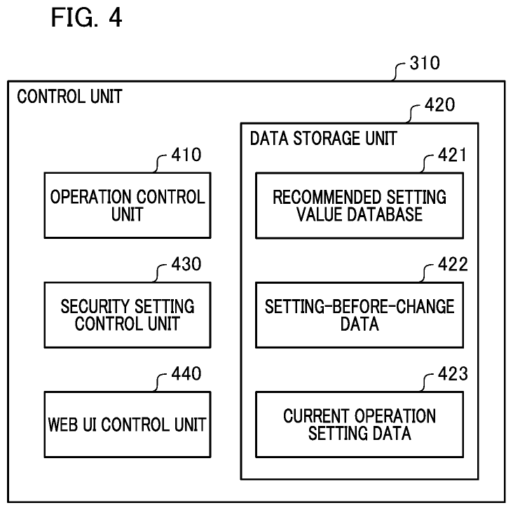

A software configuration of the image processing device 101 as an example of the information processing devices will be described by using FIG. 4. FIG. 4 is a diagram illustrating a software configuration of the image processing device. Each component illustrated in FIG. 4 is realized by the CPU 311 executing programs stored in a memory (the ROM 312 or the HDD 314). The image processing device 101 includes an operation control unit 410, a data storage unit 420, a security setting control unit 430, and a web UI control unit 440.

The operation control unit 410 displays a screen for the user on the operation unit 320. Also, the operation control unit 410 detects user's operations and switches screens and updates display on the basis of detection results.

The data storage unit 420 stores data in the HDD 314 and reads data from the HDD 314 in response to a request from another control unit. The data storage unit 420 stores information related to setting of security functions in addition to setting information for determining operations of the image processing device 101. Specifically, a recommended setting value database 421, a setting-before-change data 422, and current operation setting data 423 are stored.

The recommended setting value database 421 is a database that stores combinations of setting items and setting values of security functions suitable for the installation environment of the image processing device 101 in association with installation environments divided into a plurality of categories. The image processing device 101 manages a plurality of mutually different setting values (a plurality of first setting values) corresponding to the plurality of setting items in association with a plurality of utilization environments of the image processing device in the recommended setting value database 421. In the present embodiment, the recommended setting value database 421 stores security measures to be recommended for each installation environment illustrated in Table 1. The setting items are security measures such as the encryption of the communication path and the invalidation of a legacy protocol. The setting values are illustrated as “ON” in Table 1. The setting items for which setting values are blanks (oblique lines) in Table 1 represent that there are no recommended setting values. Setting values related to the setting items with no recommended setting values are not changed by collective setting for security in accordance with the installation environments, and setting values before a change in setting are taken over. In the present embodiment, the recommended setting value database 421 is defined by the vendor of the image processing device 101 in advance and is stored in the data storage unit 420. The setting-before-change data 422 is data saving combinations of setting items and setting values before security setting in accordance with the installation environment of the image processing device 101 is performed. In other words, the setting-before-change data 422 saves setting values before a change in setting by selecting the installation environment.

The setting-before-change data 422 is data storing a combination of setting items and setting values before the security setting according to the installation environment of the image processing device 101 is performed. That is, the setting values before the setting due to the change of the installation environment is changed are stored. The setting-before-change data 422 is used to restore setting values in a case where a problem that it is not possible to use a function that an end user desires due to the operation setting after collection setting or the like occurs when the security setting control unit 430 performs collective setting for security in accordance with the installation environment. In the present embodiment, the setting-before-change data 422 is stored when the installation environment is selected by the image processing device 101 for the first time or when a setting cancellation button 503, which will be described later, is pressed and the installation environment is selected for the first time. Therefore, the setting-before-change data 422 is not updated in a case where the user successively select environment types.

The current operation setting data 423 is data saving combinations of setting items and setting values that are being currently applied to the image processing device 101. At the time of a change in setting, the current operation setting data 423 is rewritten. The rewritten current operation setting data 423 is read by a program by the image processing device 101 being restarted after the change in setting, and the image processing device 101 is operated with the applied setting.

The security setting control unit 430 performs setting of security functions for the image processing device 101 in response to an instruction from the user that the operation control unit 410 detects. In the present embodiment, the security setting control unit 430 performs collective setting of security functions suitable for the installation environment selected by the user in addition to setting of each setting items designated by the user. Note that the collective setting in the present embodiment is a function capable of collectively setting recommended setting values for typical security functions defined by the vendor. In the present embodiment, the seven setting items described in Table 1 are assumed to be setting targets of the collective setting function. Note that the collective setting function is a function of collectively setting the recommended setting values and has different characteristics from those of a security policy function of forcing constant inhibition of a specific function and inhibiting a change of setting for a specific setting item to a setting that does not meet a policy. In other words, the user such as an administrator can change setting values for the individual setting items to other setting values again via a screen for changing individual settings, which is not illustrated, in accordance with an actual utilization condition even in a case where collective setting is performed by using the collective setting function. Also, the security setting control unit 430 saves current setting backup in the setting-before-change data 422 when collective setting is performed. Also, the security setting control unit 430 provides a report and a screen for changing setting related to setting for security, which will be described later.

The web user interface (UI) control unit 440 performs control of a setting screen displayed on an external information processing device such as the PC 121 via the network I/F 318. A web page such as a report screen provided on a web browser from the web UI control unit 440 of the image processing device 101 is displayed on a display unit of the PC 121, for example. Note that the device on which the report screen is displayed may be an information processing device such as another PC or a tablet terminal. The user can refer to and change the setting for the image processing device 101 by using the setting screen on the web browser provided by the web UI control unit 440. Also, the web UI control unit 440 may include a function of importing and exporting the recommended setting value database 421. The user can create and edit a data file related to the recommended setting value database 421 on the PC 121 by the web UI control unit 440 including the function of importing and exporting the recommended setting value database 421. Also, it is possible to transmit a data file related to the recommended setting value database 421 after editing to the image processing device 101 and cause the data storage unit 420 to store the data file.

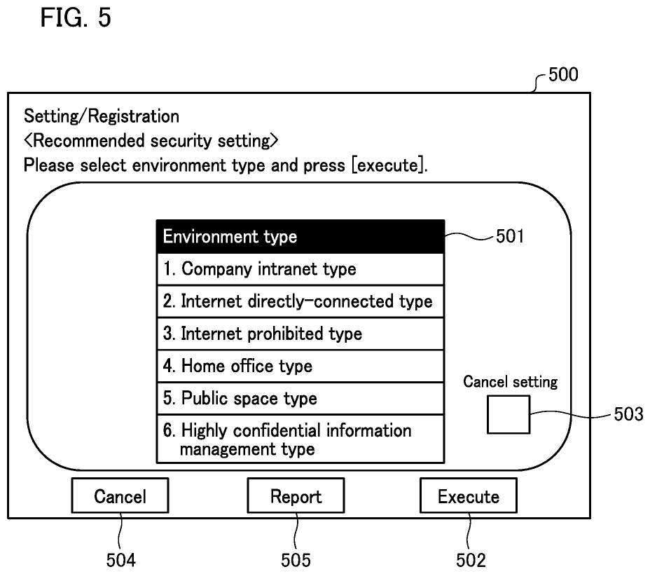

A security collective setting screen displayed on the operation unit 320 of the image processing device 101 will be described using FIG. 5. FIG. 5 is a diagram illustrating an example of the security collective setting screen according to the first embodiment. Note that although a security collective setting screen 500 displayed on the operation unit 320 of the image processing device 101 in the present embodiment will be described, the security collective setting screen is not limited thereto. For example, it is also possible to employ a configuration in which a web page similar to that of the security collective setting screen 500 is provided to a web browser of an external information processing device by using the web UI control unit 440 to perform a setting operation via the web page.

The security collective setting screen 500 is a screen that the operation control unit 410 displays on the operation unit 320. The security collective setting screen includes an installation environment list 501, an execution button 502, a setting cancellation button 503, a cancel button 504, and a report button 505. The installation environment list 501 is a button for the user to select an environment type in accordance with the installation environment. In the installation environment list 501, environment types in accordance with a company intranet environment, an Internet prohibited environment, an Internet directly connected environment, a public space environment, a home office environment, and a highly confidential information management environment are displayed.

The user performs operations of selecting the installation environment of the image processing device 101 from the installation environment list 501 and pressing the execution button 502 on the security collective setting screen 500. Once the operation control unit 410 of the image processing device 101 detects pressing of the execution button 502, the security setting control unit 430 causes security setting in accordance with the installation environment selected by the user from the installation environment list 501 to be applied to the image processing device 101. Specifically, in a case where no environment type has been set in the current operation setting data 423 first, the security setting control unit 430 reads the current operation setting data 423 from the data storage unit 420 and overwrites the setting-before-change data 422. In this manner, data of combinations of setting items and setting values that have been applied before the user selects the environment type on the security collective setting screen 500 is saved in the setting-before-change data 422. Next, the security setting control unit 430 reads recommended setting values (a plurality of first setting values) for the installation environment selected by the user from the recommended setting value database 421 from the data storage unit 420 and overwrites the current operation setting data 423.

In a case where the pressing of the setting cancellation button 503 is detected by the operation control unit 410, the security setting unit 430 reads the setting-before-change data 422 from the data storage unit 420, overwrites the current operation setting data 423, and thereby cancel out the current setting. In a case where pressing of the cancel button 504 is detected by the operation control unit 410, the security setting control unit 430 closes the security collective setting screen 500.

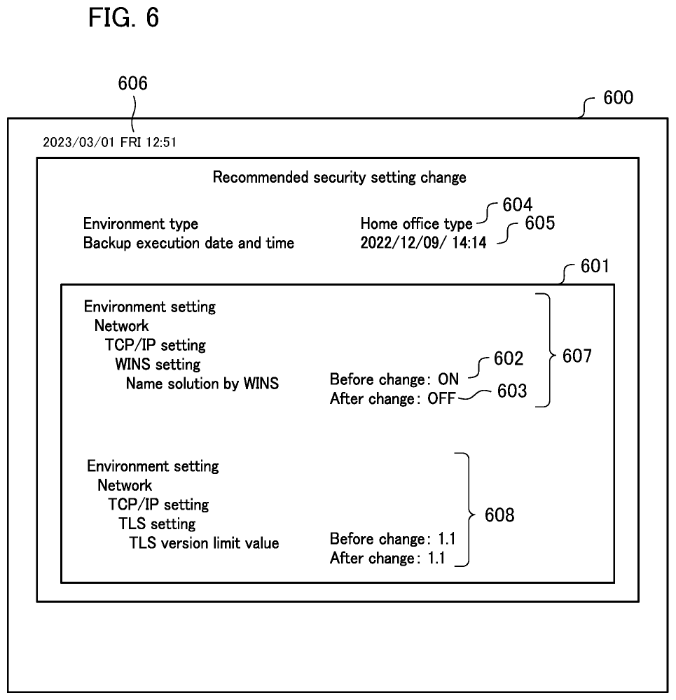

The report button 505 is a button for outputting a setting change report illustrated in FIG. 6, that is, a button for receiving an instruction to provide a report. The setting change report is a report in which current setting and setting before a collective setting change in accordance with a selection of a utilization environment (an installation environment and a utilization type) of the image processing device are compared. The user can specify setting, convenience or the like of which has been degraded due to the change in setting, and individually change only the setting by checking the setting change report. Once pressing of the report button 505 is detected by the operation control unit 410, the security setting control unit 430 reads the current operation setting data 423 and the setting-before-change data 422 from the data storage unit 420. Also, the security setting control unit 430 generates the setting value change report from the current operation setting data 423 and the setting-before-change data 422. Then, the security setting control unit 430 transmits the generated setting value change report to the printer I/F 316, and the printer 330 prints the setting change report. Note that although the example in which the setting change report is output by the printer 330 and is thereby presented to the user is described in the present embodiment, the present invention is not limited thereto. For example, the setting change report may be saved in a saving destination of scan data, may be displayed on the operation unit 320 of the image processing device 101, or may be displayed on an external device by the web UI control unit 440.

The setting change report will be described by using FIG. 6. FIG. 6 is a diagram illustrating an example of the setting change report according to the first embodiment. A setting change report 600 is a report in which the current security setting of the image processing device 101 is compared with the setting before a collective setting change for security in accordance with the selection of the utilization environment (the installation environment, the utilization type) of the image processing device 101. The setting change report 600 is output from the printer 330 of the image processing device 101. A setting list 601 is displayed in the setting change report 600. The setting list 601 is a list displaying comparison between the setting based on the setting values saved in the current operation setting data 423 with the setting based on the setting values saved in the setting-before-change data 422. For each setting, a setting value of the setting-before-change data 422 is displayed in a before-change section 602, and a setting value of the current operation setting value 423 is displayed in an after-change section 603.

Although setting before and after changes in WINS setting 607 and TLS setting 608 is displayed as an example in the setting list 601 illustrated in FIG. 6, setting displayed in the setting list 601 is not limited thereto. The WINS setting 607 is setting corresponding to invalidation of a legacy protocol. In a case where the invalidation of the legacy protocol is set to “ON”, the function of using WINS is invalidated, and name solution by WINS is turned “OFF”. In a case where the invalidation of the legacy protocol is not set to “ON”, the function using WINS is not invalidated, and name solution using WINS is turned “ON”. In the example illustrated in FIG. 6, name solution using WINS is turned “ON”, and collective setting for security is changed to “OFF” before the collective setting for security of a home office type is applied.

The TLS setting 608 is setting corresponding to the encryption of a communication path. In the example illustrated in FIG. 6, a TLS function of encrypting communication is effective before and after application of collective setting for security of the home office type is applied, and a TLS version lower limit is set to 1.1. Note that although a case where the setting list 601 of the setting change report 600 illustrated in FIG. 6 is displayed where there has been no change in setting as in TLS setting 608, a configuration in which the setting list 601 is not displayed in a case where there has been no change in setting may be employed. In other words, a configuration in which target setting is not displayed in the setting list 601 in a case where the current operation setting data 423 and the setting-before-change data 422 are compared and there has been no change in setting values and target setting is displayed in the setting list 601 only in a case where there has been a change in setting value may be employed.

Also, the setting change report 600 may include an environment type section 604, a backup execution date and time section 605, and an output clock time section 606. In the environment type section 604, an environment type (utilization environment) that is being currently set is displayed. In the backup execution date and time section 605, a clock time at which the setting-before-change data 422 is stored is displayed. In the output clock time section 606, a clock time at which the setting change report 600 is generated is displayed.

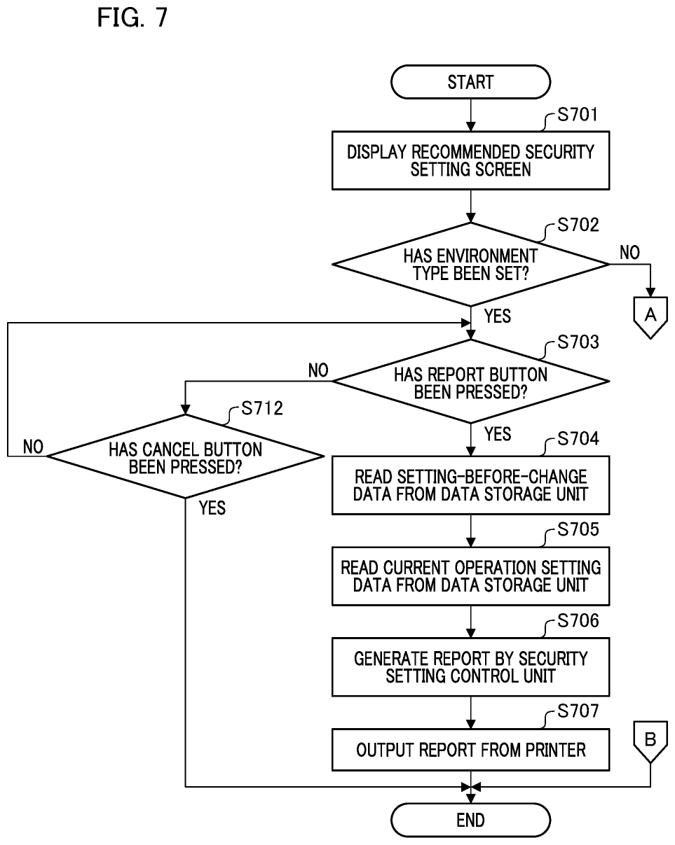

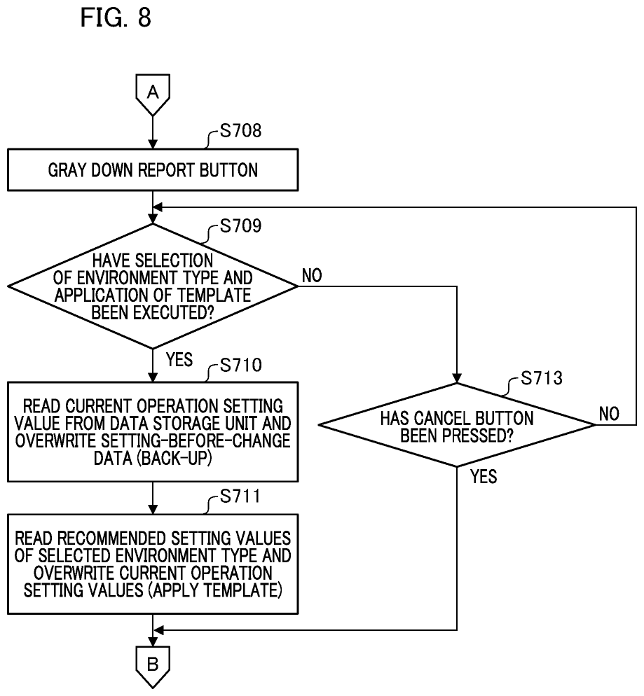

Processing before the setting change report 600 is printed will be described by using FIGS. 7 and 8. FIGS. 7 and 8 are flowchart illustrating processing of providing the setting change report according to the first embodiment. Each operation (step) illustrated in the flowcharts in FIGS. 7 and 8 is realized by the CPU 311 calling a program for realizing each control unit stored in the ROM 312 or the HDD 314 in the RAM 313 and executing the program.

Once the operation of displaying the security collective setting screen 500 on the operation unit 320 is performed, the processing illustrated in FIGS. 7 and 8 is started. In S701, the security setting control unit 430 displays the security collective setting screen on the operation unit 320. The security collective setting screen displayed in S701 is the security collective setting screen 500 through which recommended security setting is collectively set by the installation environment (environment type) of the image processing device illustrated in FIG. 5 being selected.

In S702, the security setting control unit 430 determines whether or not the installation environment (environment type) has been set from the current operation setting data 423 in the data storage unit 420. The security setting control unit 430 performs processing in S703 in a case where it is determined that the environment type has been set. On the other hand, the security setting control unit 430 performs processing in S708 in a case where it is determined that the environment type has not been set.

In S703, the security setting control unit 430 determines whether or not the report button 505 has been pressed on the security collective setting screen 500. The security setting control unit 430 determines that the report button 505 has been pressed in a case where the operation control unit 410 detects pressing of the report button 505. The security setting control unit 430 performs processing in S704 in a case where it is determined that the report button 505 has been pressed. On the other hand, the security setting control unit 430 performs processing in S712 in a case where it is determined that the report button 505 has not been pressed.

In S704, the security setting control unit 430 reads the setting-before-change data 422 from the data storage unit 420. The setting-before-change data 422 includes a plurality of setting values (a plurality of second setting values) that have been applied to the image processing device 101 when the utilization environment (environment type) is selected from the installation environment list 501 and the execution button 502 is pressed on the security collective setting screen 500. In other words, the setting-before-change data 422 includes a plurality of setting values that have been set in the image processing device 101 when an instruction to perform collective setting for security in accordance with the utilization environment is acquired. In S705, the security setting control unit 430 reads the current operation setting data 423 from the data storage unit 420. The operation setting data 423 includes a plurality of setting values (a plurality of third setting values) that have been set in the image processing device 101 when an instruction to provide the setting change report is received.

In S706, the security setting control unit 430 generates the setting change report on the basis of the setting-before-change data 422 acquired in S704 and the current operation setting data 423 acquired in S705. The setting change report includes at least some of the plurality of setting values (the plurality of second setting values) backed up before the collective setting and the plurality of current setting values (the plurality of third setting values) corresponding to the plurality of setting items for the image processing device 101. In S707, the security setting control unit 430 provides the setting change report generated in S706 to the user. For example, the security setting control unit 430 transmits the setting change report to the printer I/F 316, prints and outputs it by the printer 330, and thereby provides the setting change report to the user.

In a case where the report button 505 is not pressed on the security collective setting screen 500, the security setting control unit 430 performs processing in S712. In S712, the security setting control unit 430 determines whether or not the cancel button 504 has been pressed. The security setting control unit 430 determines that the cancel button 504 has been pressed in a case where the operation control unit 410 detects pressing of the cancel button 504. The security setting control unit 430 ends the processing in the case where it is determined that the cancel button 504 has been pressed. On the other hand, the security setting control unit 430 returns to the processing in S703 in a case where it is determined that the cancel button 504 has not been pressed.

In a case where it is determined that the environment type has not been set in S702, the security setting control unit 430 performs processing in S708. In S708, the security setting control unit 430 cannot select the report button 505 on the security collective setting screen 500. For example, the security setting control unit 430 grays down the report button 505 on the security collective setting screen 500 such that the user cannot select it.

In S709, the security setting control unit 430 determines whether the environment type has been selected and the execution button 502 has been pressed. In a case where the operation control unit 410 detects pressing of the installation environment list 501 and the execution button 502, the security setting control unit 430 determines that the environment type has been selected and the execution button 502 has been pressed. In a case where it is determined that the environment type has been selected and the execution button 502 has been pressed, the security setting control unit 430 performs processing in S710. On the other hand, in a case where it is determined that the environment type has not been selected and the execution button 502 has not been pressed, the security setting control unit 430 performs processing in S713.

In S710, the security setting control unit 430 reads the current operation setting data 423 from the data storage unit 420 and overwrites and backs up the setting-before-change data 422. In S711, the security setting control unit 430 reads recommended setting values of the environment type (installation environment) selected by the user on the installation environment list 501 from the recommended setting value database 421 in the data storage unit 420 and overwrites the current operation setting data 423. The recommended setting (template) for security in accordance with the selected installation environment is applied to the image processing device 101 through the processing in S711.

In S709, in a case where an template application environment type has been selected, and the execution button 502 has not been pressed, the security setting control unit 430 performs the processing in S713. In S713, the security setting control unit 430 determines whether or not the cancel button 504 has been pressed. The security setting control unit 430 determines that the cancel button 504 has been pressed in a case where the operation control unit 410 detects pressing of the cancel button 504. The security setting control unit 430 ends the processing in a case where it is determined that the cancel button 504 has been pressed. On the other hand, the security setting control unit 430 returns to the processing in S709 in a case where it is determined that the cancel button 504 has not been pressed.

In the present embodiment, it is possible to output the setting change report in which the setting-before-change data and the current operation setting data are compared after the user collectively sets the setting related to the security-related functions to setting suitable for the selected installation environment through the series of processing described above. In this manner, it is possible to specify a reason for degradation of convenience by checking the setting change report and to return only the setting values to the original values in a case where degradation of convenience occurs, for example, when the user cannot use desired functions due to a collective setting change. In this manner, it is possible to operate with the setting values that are more suitable for the installation environment and to enhance convenience of setting for the security functions.

### Second Embodiment

In the first embodiment, the configuration of outputting the setting change report 600 in which the setting-before-change data 422 and the current operation setting data 423 are compared as illustrated in the security collective setting screen 500 in FIG. 5 and the setting change report 600 in FIG. 6 has been illustrated as an example. In the second embodiment, a configuration of outputting a setting change report in which current operation setting data 423 and recommended setting values of a selected environment type are compared is output when a user selects the environment type (utilization environment) will be described. Note that since a hardware configuration and a software configuration of an image processing device 101 according to the present embodiment are similar to those in the first embodiment, description will be omitted.

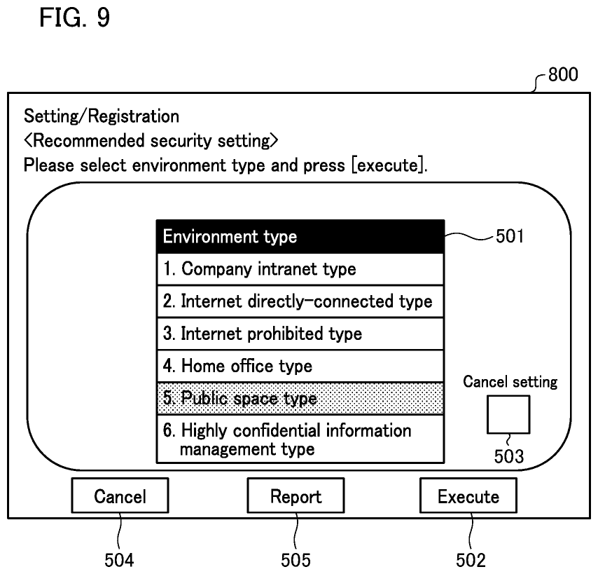

A screen configuration in the present embodiment will be described by using FIG. 9. FIG. 9 is a diagram illustrating an example of a security collective setting screen according to the second embodiment. Note that although a setting screen displayed on an operation unit 320 of an image processing device 101 will be described in the present embodiment, the setting screen is not limited thereto. For example, it is possible to employ a configuration in which a web page similar to a security collective setting screen 800 is provided to a web browser of an external information processing device by using a web UI control unit 440 such that a setting operation is performed via the web page.

The security collective setting screen 800 is a screen that an operation control unit 410 displays on the operation unit 320. The security collective setting screen 800 includes an installation environment list 501, an execution button 502, a setting cancellation button 503, a cancel button 504, and a report button 505 similarly to the security collective setting screen 500. The security collective setting screen 800 is indicated in a state where an environment type (utilization environment) has been selected in the installation environment list 501. In the example illustrated in FIG. 9, a “public space type” has been selected as an environment type (utilization environment) as an example.

In a case where the operation control unit 410 detects that the user has selected an environment type on the installation environment list 501 and has pressed the report button 505, a security setting control unit 430 provides a setting value change report. Specifically, the security setting control unit 430 reads the current operation setting data 423 and recommended setting values of the selected environment type in a recommended setting value database 421 from a data storage unit 420 first. Also, the security setting control unit 430 generates a setting value change report from the current operation setting data 423 and the recommended setting values of the selected environment type in the recommended setting value database 421 and transmits the setting value change report to a printer I/F 316. Once the printer I/F 316 detects reception of the setting value change report, the printer I/F 316 transmits the setting value change report to a printer 330, and the printer 330 prints the setting change report.

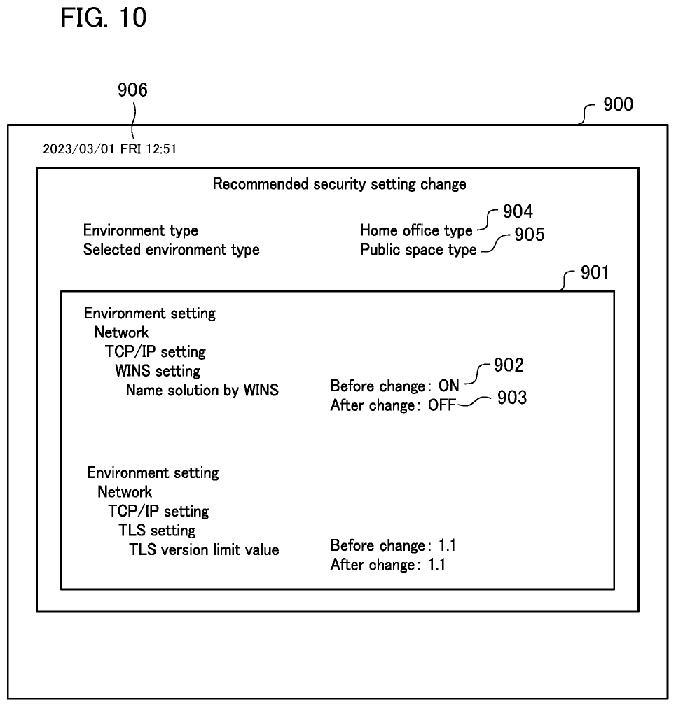

In the present embodiment, a setting change report 900 output from the printer 330 of the image processing device 101 will be described by using FIG. 10. FIG. 10 is a diagram illustrating an example of the setting change report according to the second embodiment. The setting change report 900 is a report in which current setting of the image processing device 101 and setting corresponding to the environment type (utilization environment) selected by the user are compared. In other words, a setting list 901 is a list that displays comparison between the current operation setting data 423 and the recommended setting values of the selected environment type in the recommended setting value database 421.

The setting list 901 is displayed in the setting change report 900. The setting list 901 is a list that displays comparison between setting based on setting values saved in the current operation setting data 423 and setting based on setting values of the selected environment type saved in the recommended setting value database 421. For each setting, setting values of the current operation setting data 423 is displayed in a before-change section 902, and setting values of the recommended setting value database 421 corresponding to the selected environment type is displayed in the after-change section 903. Note that a configuration in which the current operation setting data 423 and the recommended setting values of the selected environment type in the recommended setting value database 421 are compared in the setting list 901 and in a case where there has been no change in setting values, the target setting is not displayed in the setting list 901 may be employed.

Also, a current environment type section 904, a selected environment type section 905, and an output clock time section 906 may be included in the setting change report 900. In the current environment type section 904, the environment type that is being currently set is displayed. In the selected environment type section 905, the environment type selected in the installation environment list 501 when the user presses the report button 505 on the security collective setting screen 800 is displayed. In the output clock time section 906, a clock time at which the setting change report 900 has been generated is displayed.

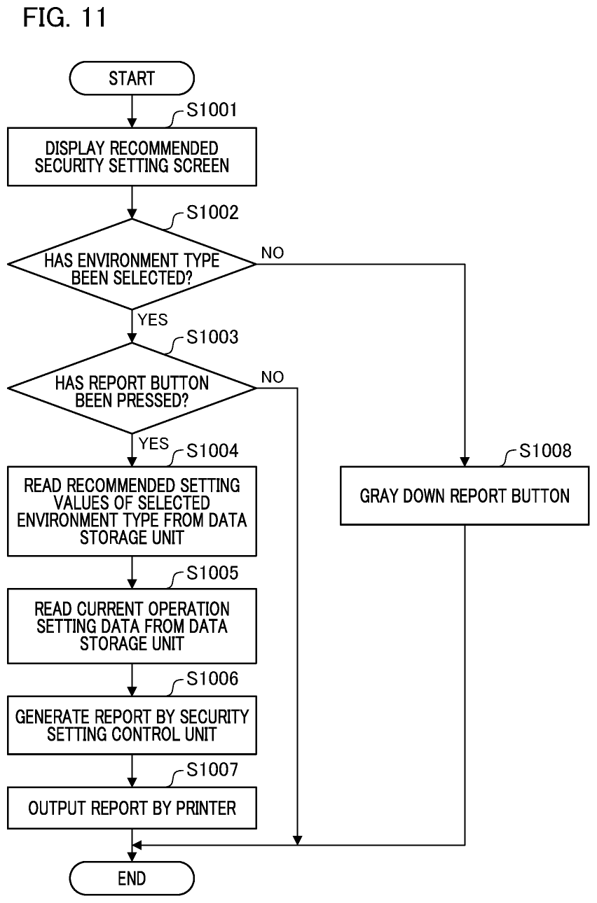

Processing before the setting change report 900 is printed will be described by using FIG. 11. FIG. 11 is a flowchart illustrating processing of providing the setting change report according to the second embodiment. Each operation (step) illustrated in the flowchart in FIG. 11 is realized by a CPU 311 calling a program for realizing each control unit stored in an ROM 312 or an HDD 314 in a RAM 313 and executing the program.

Once the operation of displaying the security collective setting screen 800 is performed on the operation unit 320, processing illustrated in FIG. 11 is started. In S1001, the security setting control unit 430 displays a security collective setting screen on the operation unit 320. The security collective setting screen displayed in S1001 is a security collective setting screen 800 on which recommended security setting is collectively set by selecting an installation environment (environment type) of the image processing device illustrated in FIG. 8.

In S1002, the security setting control unit 430 determines whether or not the installation environment (environment type) has been set from the current operation setting data 423 in the data storage unit 420. The security setting control unit 430 performs processing in S1003 in a case where it is determined that the environment type has been set. On the other hand, the security setting control unit 430 performs processing in S1008 in a case where it is determined that the environment type has not been set.

In S1003, the security setting control unit 430 determines whether or not the report button 505 has been pressed on the security collective setting screen 800. The security setting control unit 430 determines that the report button 505 has been pressed in a case where the operation control unit 410 detects pressing of the report button 505. The security setting control unit 430 performs processing in S1004 in a case where it is determined that the report button 505 has been pressed. On the other hand, the security setting control unit 430 ends the processing in a case where it is determined that the report button 505 has not been pressed.

In S1004, the security setting control unit 430 reads recommended setting values of the environment type selected on the security collective setting screen 800 from the recommended setting value database 421 in the data storage unit 420. The recommended setting values are a plurality of setting values (a plurality of first setting values) managed in the recommended setting value database 421 and managed in association with the utilization environment. In S1005, the control unit 430 reads the current operation setting data 423 from the data storage unit 420. The operation setting data 423 is a plurality of setting values (a plurality of third setting values) set in the image processing device 101 when an instruction to provide a setting change report is received.

In S1006, the security setting control unit 430 generates the setting change report 900 on the basis of the recommended setting values of the selected environment type in the recommended setting value database 421 acquired in S1004 and the current operation setting data 423 acquired in S1005. In S1007, the security setting control unit 430 provides the setting change report 900 to the user. For example, the security setting control unit 430 transmits the generated setting change report 900 to the printer I/F 316, and the printer 330 prints the setting change report 900.

In a case where the environment type has not been set in S1002, processing in S1008 is performed. In S1008, the security setting control unit 430 changes the report button 505 on the security collective setting screen 800 to be non-selectable. For example, the security setting control unit 430 transmits an instruction to gray down the report button 505 on the security collective setting screen 800 to the operation control unit 410, and the operation control unit grays down the report button 505 and ends the processing illustrated in FIG. 11.

It is possible to present, to the user, the setting change report in which the current operation setting and the collective setting corresponding to the selected utilization environment (utilization type) are compared through the series of processing described above. The user can check whether or not there has been degradation of convenience due to a change in setting before collectively setting security related-function setting to setting suitable for the selected installation environment. Also, it is possible to change only setting values, which do not cause degradation of convenience, to the recommended setting values and perform operation by checking the setting change report. It is thus possible to enhance convenience of setting of the security functions according to the present embodiment.

### Third Embodiment

In the first embodiment, the configuration in which the current operation setting data 423 is backed up in the setting-before-change data 422 at the time of the setting of the environment type and the setting change report 600 comparing the backed up setting-before-change data 422 and the current operation setting data 423 is output has been illustrated as an example. Also, in the second embodiment, the configuration in which the setting change report 900 of comparing the current operation setting data 423 and the recommended setting values of the selected environment type saved in the recommended setting value database 421 is output before the recommended setting values of the selected environment type are applied has been illustrated as an example. In a third embodiment, a back-up is performed by overwriting setting-before-change data 422 with current operation setting data 423 when a user selects an environment type and recommended setting values of the selected environment type are applied. Also, a configuration in which a setting change report of comparing the backed up setting-before-change data 422 and the recommended setting values of the selected environment type is output will be described. Since a hardware configuration and a software configuration of an image processing device 101 according to the present embodiment are similar to those in the first embodiment, description will be omitted. Also, a configuration of a security collective setting screen in the present embodiment is similar to the configuration of the security collective setting screen 800 illustrated in FIG. 9, a configuration of a setting change report in the present embodiment is similar to the configuration of the setting change report 600 illustrated in FIG. 6, and description will thus be omitted.

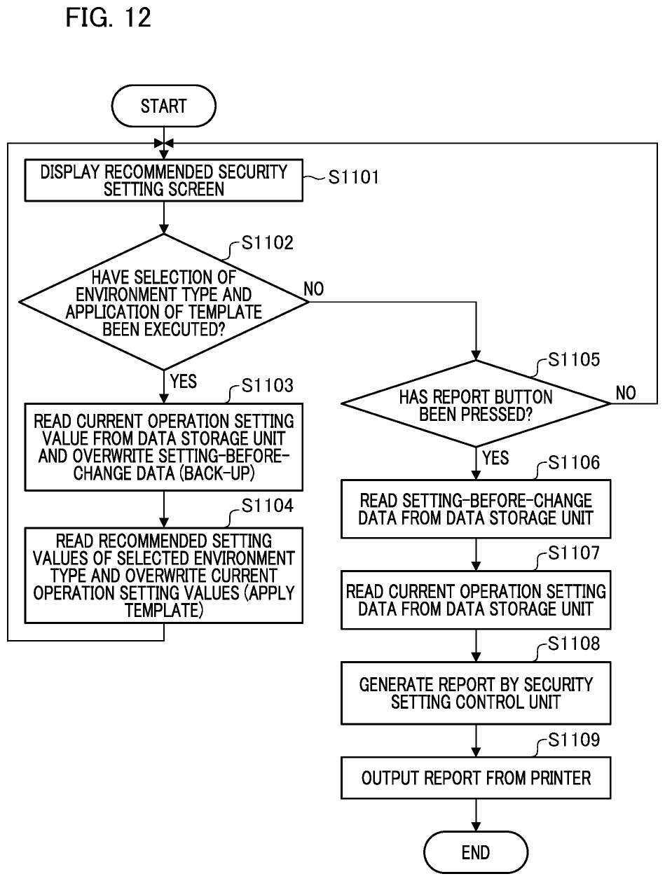

Processing before the setting change report is printed will be described by using FIG. 12. FIG. 12 is a flowchart illustrating processing of providing the setting change report according to the third embodiment. Each operation (step) illustrated in the flowchart in FIG. 12 is realized by a CPU 311 calling a program for realizing each control unit stored in a ROM 312 or an HDD 314 in a RAM 313 and executing the program.

Once an operation of displaying a security collective setting screen 800 on an operation unit 320 is performed, processing illustrated in FIG. 12 is started. In S1101, a security setting control unit 430 displays the security collective setting screen on the operation unit 320. The security collective setting screen displayed in S1001 is the security collective setting screen 800 on which recommended security setting is collectively set by selecting an installation environment (environment type) of the image processing device illustrated as illustrated in FIG. 8.

In S1102, the security setting control unit 430 determines whether or not an environment type (utilization environment) has been selected and an execution button 502 has been pressed on the security collective setting screen 800. The security setting control unit 430 determines that the environment type has been selected and the execution button 502 has been pressed in a case where the operation control unit 410 detects pressing of a installation environment list 501 and the execution button 502. In a case where it is determined that the environment type has been selected and the execution button 502 has been pressed, the security setting control unit 430 performs processing in S1103. On the other hand, the security setting control unit 430 performs processing in S1105 in a case where it is determined that selection of the environment type and the pressing of the execution button 502 have not been performed.

In S1103, the security setting control unit 430 reads current operation setting data 423 from a data storage unit 420, overwrites setting-before-change data 422, and thereby backs up the data. In S1104, the security setting control unit 430 reads recommended setting values of the environment type (installation environment) selected by the user on the installation environment list 501 from the recommended setting value database 421 in the data storage unit 420 and overwrites the current operation data 423. Recommended setting (template) for security in accordance with the selected installation environment is applied to the image processing device 101 through the processing in S1104. Once the processing in S1104 is completed, the processing returns to S1101.

On the other hand, in a case where an execution button 803 is not pressed in S1102, processing in S1105 is performed. In S1105, the security setting control unit 430 determines whether or not the report button 505 has been pressed on the security collective setting screen 800. The security setting control unit 430 determines that the report button 505 has been pressed in a case where the operation control unit 410 detects pressing of the report button 505. The security setting control unit 430 performs processing in S1106 in a case where it is determined that the report button 505 has been pressed. On the other hand, the security setting control unit 430 returns to the processing in S1101 in a case where it is determined that the report button 505 has not been pressed.

In S1106, the security setting control unit 430 reads the setting-before-change data 422 from the data storage unit 420. The setting-before-change data 422 includes a plurality of setting values (a plurality of second setting values) that have been applied to the image processing device 101 when the utilization environment (environment type) is selected from the installation environment list 501 and the execution button 502 is pressed on the security collective setting screen 800. In other words, the setting-before change data 422 includes a plurality of setting values that have been set in the image processing device 101 when an instruction to perform collective setting for security in accordance with the utilization environment is acquired. In S1107, the security setting control unit 430 reads the current operation setting data 423 from the data storage unit 420. The operation setting data 423 includes a plurality of setting values (a plurality of third setting values) which have been set in the image processing device 101 when an instruction to provide the setting change report is received.

In S1108, the security setting control unit 430 generates a setting change report on the basis of the setting-before-change data 422 acquired in S1106 and the current operation setting data 423 acquired in S1107. The setting change report includes at least some of a plurality of setting values (a plurality of second setting values) backed up before the collective setting and a plurality of current setting values (a plurality of third setting values) corresponding to a plurality of setting items for the image processing device 101. In S1109, the security setting control unit 430 provides, to the user, the setting change report generated in S1108. For example, the security setting control unit 430 transmits the setting change report to a printer I/F 316, and a printer 330 provides the setting change report to the user by printing and outputting it.

In this manner, once the user selects the environment type and presses the execution button 502, the image processing device 101 executes the processing in S1103 and S1104. The setting-before-change data 422 is overwritten with the current operation setting data 423, and the recommended setting values of the selected environment type are applied to the image processing device 101 through the processing in S1103 and S1104. If the user subsequently presses the report button 505, the processing in S1106 to S1109 is executed, and the setting change report in which the backed up setting-before-change data 422 and the recommended setting values of the environment type selected and applied are compared is output.

Note that although the configuration in which the setting change report is provided by the report button 505 being pressed after the execution button 502 is pressed has been described in the present embodiment, and the configuration is not limited thereto. For example, the execution button 502 may be pressed, the processing in S1103 and S1104 may be executed, and the processing in S1106 to S1109 may then be performed. In this manner, it is possible to provide, to the user, the report in which the setting values for the collective setting in accordance with the newly applied utilization environment and the backed-up setting values before the change in setting are compared.

It is possible to overwrite the setting-before-change data with the current operation setting values, back up the data, and provide the setting change report in which the setting-before-change data and the setting data suitable for the selected installation environment are compared when the setting suitable for the selected installation environment is collectively set through the series of processing described above. The user can check whether or not there has been degradation of convenience due to a change in setting by the setting change report and to enhance convenience of setting for the security function.

### Fourth Embodiment

In the first and third embodiments, the configuration in which the setting-before-change data 422 is overwritten with the current operation setting data 423 thereby to back up the data and the setting change report in which the setting-before-change data 422 and the recommended setting values of the selected environment type are compared is output has been described. In a fourth embodiment, a configuration in which backed-up setting-before-change data 422 and recommended setting values of a selected environment type are compared, only setting values with setting changes are displayed on an operation unit 320, and a user can individually change the setting values on the operation unit 320 will be described. Note that a hardware configuration and a software configuration of an image processing device 101 according to the present embodiment are similar to those in the first embodiment and description thereof will thus be omitted.

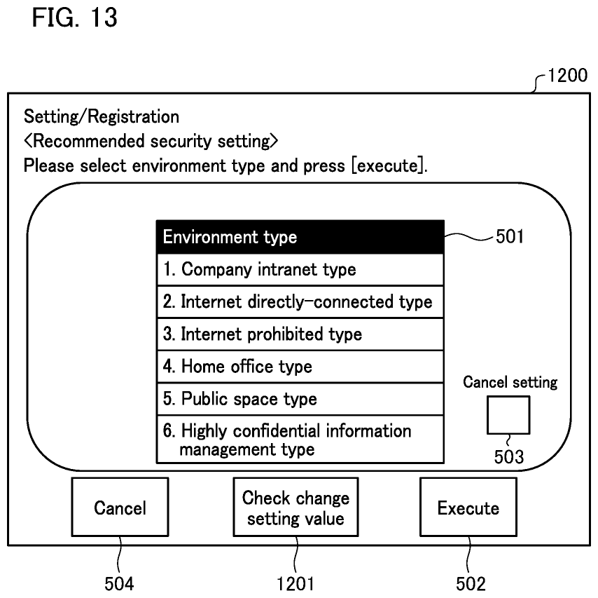

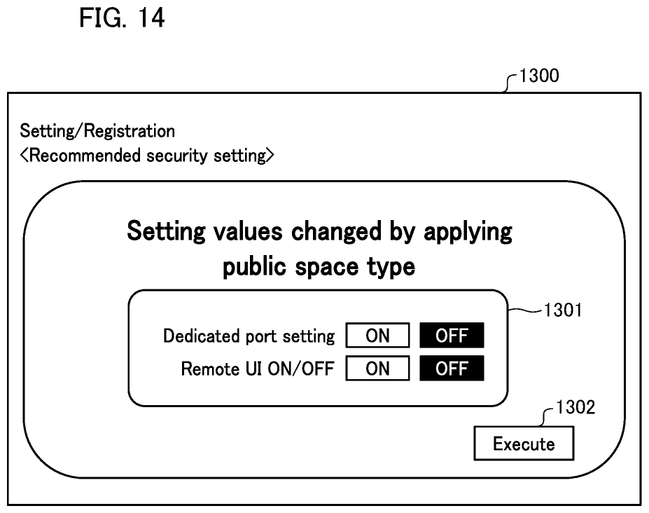

A screen configuration according to the present embodiment will be described by using FIGS. 13 and 14. FIGS. 13 and 14 illustrate, as an example, a setting screen displayed on the operation unit 320 of the image processing device 101. Note that although the setting screen displayed on the operation unit 320 of the image processing device 101 will be described in the present embodiment, the setting screen is not limited thereto. For example, it is also possible to employ a configuration in which a web page similar to the security collective setting screen 500 is provided to a web browser of an external information processing device by using a web UI control unit 440 and a setting operation is performed via the web page.

First, a security collective setting screen displayed on the operation unit 320 of the image processing device 101 will be described by using FIG. 13. FIG. 13 is a diagram illustrating an example of the security collective setting screen according to the fourth embodiment. A security collective setting screen 1200 is a screen displayed on the operation unit 320 by an operation control unit 410. The security collective setting screen 1200 includes an installation environment list 501, an execution button 502, a setting cancellation button 503, a cancel button 504, and a change setting value check button 1201.

The change setting value check button 1201 is a button for displaying a setting change screen 1300 illustrated in FIG. 14. Once the user presses the change setting value check button 1201, a security setting control unit 430 reads current operation setting data 423 and backed-up setting-before-change data 422 from a data storage unit 420. Then, the security setting control unit 430 compares the current operation setting data 423 with the setting-before-change data 422, extracts setting values with changes, and displays the setting values on the setting change screen. In a case where the setting values with changes is displayed on the setting change screen, the security setting control unit 430 performs display capable of receiving an operation of changing setting values on the screen. In other words, the setting change screen is a screen for the setting change report on which an operation of changing setting can be performed.

Next, the setting change screen 1300 displayed on the operation unit 320 of the image processing device 101 will be described by using FIG. 14. FIG. 14 is a diagram illustrating an example of the setting change screen. As the setting change screen 1300 illustrated in FIG. 14, an example in which a “public space type” has been selected as a utilization environment (utilization type) of the image processing device 101 is illustrated. The setting change screen 1300 includes a change setting value list 1301 and a setting change execution button 1302.

The change setting value list 1301 is a list that displays only setting values with changes as a result of comparison between the current operation setting data 423 and the setting-before-change data 422. In the example illustrated in FIG. 14, an example in which “dedicated port setting” and “remote UI ON/OFF” have been changed to “OFF” is illustrated. Each setting value displayed in the change setting value list 1301 is displayed such that the current setting value can be checked and a change in setting can be received. In the example illustrated in FIG. 14, the change setting value list 1301 displays such that switching between “ON/OFF” of setting values can be selected. The setting change execution button 1302 is a button that reflects the setting values selected on the change setting value list 1301 by the user. The user changes setting values that the user desires to change on the change setting value list 1301 and presses the setting change execution button 1302. The security setting control unit 430 overwrites only the setting values changed by the user on the change setting value list 1301 with the current operation data 423 in a case where pressing of the setting change execution button 1302 is detected.

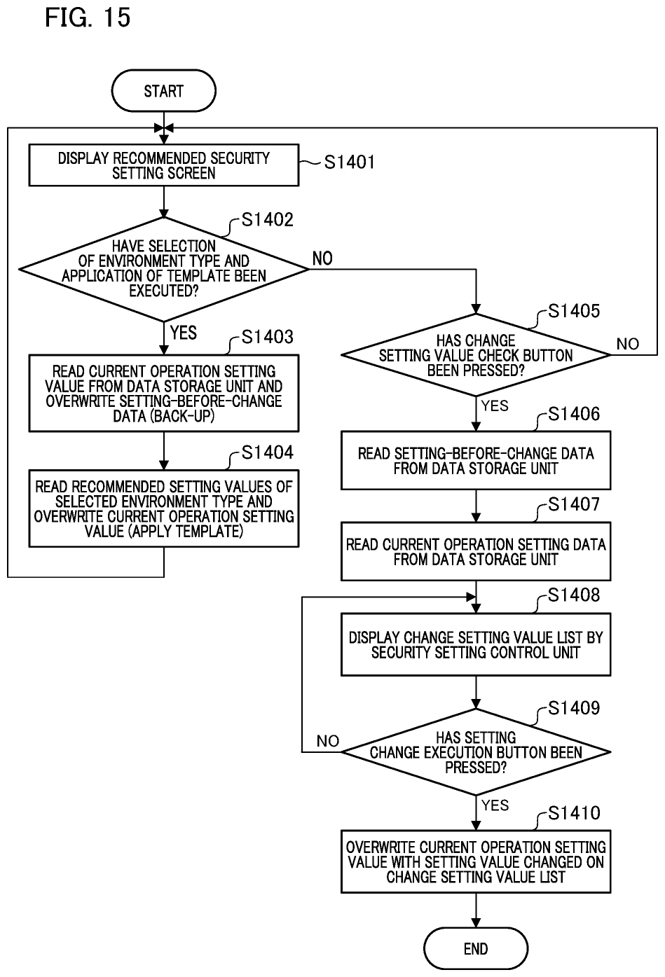

Processing before a change in setting is received after the setting change screen is provided will be described by using FIG. 15. FIG. 15 is a flowchart illustrating processing related to the setting change screen according to the fourth embodiment. Each operation (step) illustrated in the flowchart in FIG. 12 is realized by a CPU 311 calling a program for realizing each control unit stored in a ROM 312 or an HDD 314 in a RAM 313 and executing the program.

Once an operation of displaying the security collective setting screen 1200 is performed on the operation unit 320, processing illustrated in FIG. 15 is started. In S1401, the security setting control unit 430 displays the security collective setting screen on the operation unit 320. The security collective setting screen displayed in S1401 is a security collective setting screen 1200 on which recommended security setting is collectively set by selecting the installation environment (environment type) of the image processing device illustrated in FIG. 13.

S1402, the security setting control unit 430 determines whether or not the environment type (utilization environment) has been selected and the execution button 502 has been pressed on the security collective setting screen 1200. The security setting control unit 430 determines that the environment type has been selected and the execution button 502 has been pressed in a case where the operation control unit 410 detects pressing of the installation environment list 501 and the execution button 502 is detected. In a case where it is determined that the environment type has been selected and the execution button 502 has been pressed, the security setting control unit 430 performs processing in S1403. On the other hand, in a case where it is determined that the environment type has not been selected and the execution button 502 has not been pressed, the security setting control unit 430 performs processing in S1405.

In S1403, the security setting control unit 430 reads the current operation data 423 from the data storage unit 420, overwrites the setting-before-change data 422 with the current operation data 423, and backs up the data. In S1404, the security setting control unit 430 reads recommended setting values of the environment type (installation environment) selected by the user on the installation environment list 501 from the recommended setting value database 421 in the data storage unit 420 and overwrites the current operation data 423. Recommended setting (template) for security in accordance with the selected installation environment is applied to the image processing device 101 through the processing in S1104. Once the processing in S1404 is completed, the processing returns to S1401.

On the other hand, in a case where the execution button 803 is not pressed in S1402, processing in S1405 is performed. In S1405, the security setting control unit 430 determines whether or not the change setting value check button 1201 has been pressed on the security collective setting screen 1200. The security setting control unit 430 determines that the change setting value check button 1201 has been pressed in a case where the operation control unit 410 detects pressing of the change setting value check button 1201. The security setting control unit 430 performs processing in S1406 in a case where it is determined that the change setting value check button 1201 has been pressed. On the other hand, the security setting control unit 430 returns to the processing in S1401 in a case where it is determined that the change setting value check button 1201 has not been pressed.

In S1406, the security setting control unit 430 reads the setting-before-change data 422 from the data storage unit 420. The setting-before-change data 422 includes a plurality of setting values (a plurality of second setting values) that have been applied to the image processing device 101 when the utilization environment (environment type) is selected from the installation environment list 501 and the execution button 502 is pressed on the security collective setting screen 1200. In other words, the setting-before-change data 422 includes a plurality of setting values that have been set in the image processing device 101 when an instruction to perform collective setting for security in accordance with the utilization environment is acquired. In S1407, the security setting control unit 430 reads the current operation setting data 423 from the data storage unit 420. The operation setting data 423 includes a plurality of setting values (a plurality of third setting values) that have been set in the image processing device 101 when an instruction to provide the setting change report is received.

In S1408, the security setting control unit 430 generates the setting change screen 1300 and displays it on the operation unit 320 on the basis of the setting-before-change data 422 acquired in S1406 and the current operation setting data 423 acquired in S1407. The change setting value list 1301 on the setting change screen 1300 includes at least some of the plurality of backed-up setting values (the plurality of second setting values) before the collective setting and the plurality of current setting values (the plurality of third setting values) corresponding to a plurality of setting items of the image processing device 101. More specifically, the setting change screen 1300 displays setting values, which are difference between the plurality of backed-up setting values before the collective setting and the plurality of current setting values, such that the current setting values can be recognized, and it is possible to receive a change in setting values on the setting change screen 1300. Note that although the example in which only setting values corresponding to setting items, the setting values of which are different between the setting-before-change data 422 and the current operation setting data 423, are displayed has been described in the present embodiment, all setting values for security may be displayed.

In S1409, the security setting control unit 430 determines whether or not the setting change execution button 1302 on the setting change screen 1300 has been pressed. The security setting control unit 430 determines that the setting change execution button 1302 has been pressed in a case where the operation control unit 410 detects pressing of the setting change execution button 1302. The security setting control unit 430 performs processing in S1410 in a case where it is determined that the setting change execution button 1302 has been pressed. On the other hand, the security setting control unit 430 returns to the processing in S1408 and continuously displays the setting change screen 1300 in a case where it is determined that the setting change execution button 1302 has not been pressed. In S1410, the security setting control unit 430 overwrites the current operation setting data 423 with the setting values changed on the change setting value list 1301 and ends the processing illustrated in FIG. 15.

According to the present embodiment, it is possible to display, on a screen, only setting changed by collective setting for security corresponding to a utilization environment, to receive an operation of changing setting on the screen, and to change the setting through the aforementioned processing.

Note that the example in which the setting value before a change in setting backed up at the time of the collective setting for security corresponding to the utilization environment and the current setting values are compared and the change setting value list 1301 on the setting change screen 1300 is displayed on the basis of the result has been described in the present embodiment. In other words, the setting change screen 1300 is achieved by displaying the setting change report provided to the user in the first and third embodiments on the screen such that an operation of changing setting can be received. Similarly, a setting change screen that displays the setting change report in the second embodiment such that an operation of changing setting can be received may be provided. On the setting change screen in this case, setting values with changes as a result of comparison between the current operation setting data 423 and the recommended setting values of the selected environment type saved in the recommended setting value database 421 are displayed in a state where the recommended setting values can be recognized, for example. It is thus possible to provide a result of comparing the current operation setting data 423 with the recommended setting values of the selected environment type saved in the recommended setting value database 421 and to receive a user's operation before the recommended setting values of the selected environment type are applied.

### Modification Examples

Although the case where the display of the setting screen is performed on a web page provided to a web browser of an external information processing device by using the operation unit 320 of the image processing device 101 or the web UI control unit 440 of the image processing device 101 has been described, the present invention is not limited thereto. Specifically, a configuration in which display of the setting screen and generation of the operation setting data are performed on an application in an external information processing device may also be employed. The external application includes an operation control unit that displays the security collective setting screen and receives a user's operation. Also, a data storage unit that stores data similar to that of the recommended setting value database 421, the setting-before-change data 422, and the current operation setting data 423 is included. Note that the external application acquires the data similar to that of the current operation setting data 423 and the setting-before-change data 422 from the image processing device 101 via a network.

For example, in a case where the processing in the first embodiment is performed, the external application displays the security collective setting screen illustrated in FIG. 5 on the external information processing device first. The user presses the report button 505 on the external application and provides an instruction to output a report. The external application extracts the current operation setting data 423 and the setting-before-change data 422 from a database stored in the external application. Processing similar to S701 to S707 in FIGS. 7 and 8 is performed inside the external application, and the setting change report is displayed on the screen and is thereby provided to the user. Also, a configuration in which the external application transmits the generated setting change report to the image processing device 101 and the image processing device 101 prints the setting change report may be employed. For example, an instruction to change operation setting is transmitted by using a simple network management protocol (SNMP) SetRequest operation. Note that the scheme for providing an instruction for a communication protocol used to change a setting or for the change in setting is not limited to SNMP. The user can check the setting change report of the image processing device 101 on the application in the external information processing device through the above processing. Also, it is possible to provide an instruction to output the setting change report on the application in the external information processing device and to output the setting change report from the image processing device 101.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-044203, filed Mar. 20, 2023, which is hereby incorporated by reference wherein in its entirety.

What is claimed is:

1. An information processing device comprising:
a memory storing instructions; and
a processor executing the instructions causing the information processing device to:
receive a selection of one utilization environment from the plurality of utilization environments;
perform setting for a plurality of setting items by using the plurality of first setting values in association with the selected one utilization environment;
save a plurality of second setting values corresponding to the plurality of setting items that are set before the setting by using the plurality of first setting values is performed; and
provide a report including the saved plurality of second setting values and a plurality of third setting values set for the information processing device when an instruction to provide the report is received, which correspond to at least some of the plurality of setting items, on the basis of the instruction to provide the report from a user.

2. The information processing device according to claim 1, wherein setting values included in the report are setting values corresponding to setting items for which different setting values are set as the plurality of second setting values and as the plurality of third setting values.

3. The information processing device according to claim 1, wherein in a case where an instruction to provide the report is acquired in a state where one utilization environment has been selected from among the plurality of utilization environments, the processor provides a report including a plurality of third setting values set for the information processing device when the instruction to provide the report is received, and the plurality of first setting values in association with the selected utilization environment, which correspond to at least some of the plurality of setting items.

4. The information processing device according to claim 1, wherein the report is provided as a screen to be displayed on the information processing device.

5. The information processing device according to claim 1, wherein the report is provided as a web page to be displayed on a web browser.

6. The information processing device according to claim 1,
wherein the report is displayed as a setting change screen capable of receiving, from the user, an instruction to change setting values of setting items that are being displayed, and
the processor sets the changed setting values for the information processing device on the basis of the instruction to change the setting values on the setting change screen.

7. The information processing device according to claim 1, wherein the processor provides the report by printing the report.

8. The information processing device according to claim 1, wherein the report includes at least any of a utilization environment that is currently set for the information processing device, a date and time of saving of the plurality of second setting values, and a date and time of provision of the report.

9. The information processing device according to claim 1, wherein the information processing device is an image processing device including at least any of a printing function and a scanning function.

10. The information processing device according to claim 1, wherein the plurality of first setting values are managed corresponding to the plurality of setting items and are different from each other, in association with the plurality of utilization environments of the information processing device.

11. A control method of an information processing device, the method comprising:
receiving a selection of one utilization environment from the plurality of utilization environments;
performing setting for a plurality of setting items by using the plurality of first setting values in association with the selected one utilization environment;
saving a plurality of second setting values corresponding to the plurality of setting items that are set before the setting by using the plurality of first setting values is performed; and
providing a report including the saved plurality of second setting values and a plurality of third setting values set for the information processing device when an instruction to provide the report is received, which correspond to at least some of the plurality of setting items, on the basis of the instruction to provide the report from a user.

12. A non-transitory storage medium storing a control program of an information processing device causing a computer to perform each step of a control method of the information processing device, the method comprising:
receiving a selection of one utilization environment from the plurality of utilization environments;
performing setting for a plurality of setting items by using the plurality of first setting values in association with the selected one utilization environment;
saving a plurality of second setting values corresponding to the plurality of setting items that are set before the setting by using the plurality of first setting values is performed; and
providing a report including the saved plurality of second setting values and a plurality of third setting values set for the information processing device when an instruction to provide the report is received, which correspond to at least some of the plurality of setting items, on the basis of the instruction to provide the report from a user.
